(19) United States
(12) Patent Application Publication
(10) Pub. No.: US 2017/0235180 A1
(43) Pub. Date: Aug. 17, 2017

(54) LIQUID CRYSTAL DISPLAY DEVICE

(71) Applicant: Sharp Kabushiki Kaisha, Sakai City, Osaka (JP)

(72) Inventors: Satoshi MATSUMURA, Sakai City (JP); Mitsuhiro MURATA, Sakai City (JP); Yosuke IWATA, Sakai City (JP); Hidefumi YOSHIDA, Sakai City (JP)

(21) Appl. No.: 15/501,505

(22) PCT Filed: Jul. 29, 2015
(86) PCT No.: PCT/JP2015/071436

§ 371 Date: Feb. 3, 2017

(30) Foreign Application Priority Data
Aug. 5, 2014 (JP) 2014-159683

(51) Int. Cl. G02F 1/1343; G02F 1/1333; G02F 1/1337

(52) U.S. Cl. CPC G02F 1/13439; G02F 1/1337; G02F 1/133345; G02F 1/134363; G02F 2001/133738; G02F 2001/134372; G02F 1/1368

(57) ABSTRACT

Provided is a liquid crystal display device that employs a horizontal alignment mode providing wide viewing angles and is capable of achieving high-speed response and high transmittance. The liquid crystal display device includes a pair of substrates with fringe electric field structures and a liquid crystal layer interposed between the paired substrates. Each fringe electric field structure includes a planar electrode, a slit electrode, and an insulating film interposed between the planar electrode and the slit electrode. The liquid crystal layer includes liquid crystal molecules that align horizontally to the substrate surfaces of the paired substrates with no voltage applied. The liquid crystal molecules in the vicinity of the respective substrates are configured to rotate in the same direction from the alignment azimuth with no voltage applied when voltage is applied to each of the fringe electric field structures.

### TECHNICAL FIELD

The present invention relates to a liquid crystal display device. The present invention specifically relates to a liquid crystal display device that employs horizontal alignment as initial alignment and drives liquid crystal by fringe electric fields.

### BACKGROUND ART

Liquid crystal display devices utilize liquid crystal compositions for display. In a typical display mode of liquid crystal display devices, voltage is applied to a liquid crystal composition sealed between a pair of substrates to change the alignment state of liquid crystal molecules in the liquid crystal composition according to the strength of the applied voltage, whereby the amount of light transmission is controlled. Such liquid crystal display devices are used in various fields due to their merits such as thin profile, light weight, and low power consumption.

Among various display modes for liquid crystal display devices, a horizontal alignment mode is drawing attention in which the alignments of liquid crystal molecules are controlled by rotating the molecules mainly in a plane horizontal to (parallel to) the substrate surface because this mode tends to achieve wide viewing angle characteristics. As an example of the horizontal alignment mode, a fringe field switching (FFS) mode has been widely employed in liquid crystal display devices for smartphones and tablet computers. Such horizontal alignment modes have been studied and developed to improve the display quality. Patent Literature 1 proposes an example of a liquid crystal display device including a pair of substrates disposed on each side of a liquid crystal layer. Each substrate has a pixel electrode including a linearly extending, strip-shaped main pixel electrode and a pair of main common electrodes sandwiching the main pixel electrode and extending in the direction substantially parallel to the main pixel electrode. The pixel electrode and the common electrodes on one substrate are electrically connected to the corresponding pixel electrode and common electrodes on the other substrate.

### CITATION LIST

### Patent Literature

Patent Literature 1: JP 2013-029784 A

### SUMMARY OF INVENTION

### Technical Problem

Although the above FFS mode has advantages for achieving wide viewing angles, the response time is slower than that of vertical alignment modes such as a multi domain vertical alignment (MVA) mode. Additionally, the liquid crystal display device disclosed in Patent Literature 1 still has room for improvement in both of the response time and the transmittance.

The present invention has been made under the above current situation in the art, and aims to provide a liquid crystal display device that employs a horizontal alignment mode providing wide viewing angles and is capable of achieving high-speed response and high transmittance.

### Solution to Problem

While studying horizontal alignment modes that achieve wide viewing angles, the present inventors found that in conventional FFS modes, the fringe electric fields generated by applying voltage to the electrodes on the lower substrate are insufficient for driving liquid crystal molecules in the upper part of the liquid crystal layer, and that this is the reason for insufficient response speed. Then, the present inventors conceived an idea of providing an electrode structure for generating fringe electric fields on both of the upper and lower substrates in a liquid crystal display that employs horizontal alignment (parallel alignment) as initial alignment and is driven by fringe electric fields. Thereby, fringe electric fields are simultaneously generated on the upper and lower substrates to apply strong electric fields to liquid crystal molecules in the upper part of the liquid crystal layer in rise time (in switching from the voltage-off state to the voltage-on state). This allows liquid crystal molecules in the entire region of the liquid crystal layer to speedily rotate in the same direction to achieve high-speed response. The present inventors thus finely solved the above problem to arrive at the present invention.

Specifically, an aspect of the present invention may be a liquid crystal display device including: a first substrate with a first fringe electric field structure; a second substrate with a second fringe electric field structure; and a liquid crystal layer interposed between the first substrate and the second substrate, the first fringe electric field structure including a first planar electrode, a first slit electrode, and a first insulating film interposed between the first planar electrode and the first slit electrode, the second fringe electric field structure including a second planar electrode, a second slit electrode, and a second insulating film interposed between the second planar electrode and the second slit electrode, the liquid crystal layer including liquid crystal molecules that align horizontally to the substrate surfaces of the first substrate and the second substrate with no voltage applied, the liquid crystal molecules in the vicinity of the first substrate and the liquid crystal molecules in the vicinity of the second substrate being configured to rotate in the same direction from the alignment azimuth with no voltage applied when voltage is applied to each of the first fringe electric field structure and the second fringe electric field structure.

In contrast, the liquid crystal display device disclosed in Patent Literature 1 lacks such a fringe electric field structure and has no electrode structure suitable for high-speed rotation of liquid crystal molecules in the entire region of the liquid crystal layer.

### Advantageous Effects of Invention

The liquid crystal display device of the present invention has the above structure and thus achieves both of a horizontal alignment mode providing wide viewing angles and properties including high-speed response and high transmittance.

### BRIEF DESCRIPTION OF DRAWINGS

FIG. 1 is a schematic cross-sectional view illustrating a liquid crystal display device of an embodiment in the voltage-on state.

FIGS. 2(a) and 2(b) are schematic plan views illustrating a relation between the alignment azimuths of liquid crystal molecules and the direction of an electric field in the liquid crystal display device of the embodiment. FIG. 2(a) illustrates switching from the voltage-off state to the voltage-on state, and FIG. 2(b) illustrates switching from the voltage-on state to the voltage-off state.

FIG. 3 is a schematic plan view illustrating an example of a slit electrode.

FIG. 4 is a figure illustrating calculation results of the electric fields (lines of electric force) and the alignment distribution (alignment azimuths of liquid crystal molecules) in the liquid crystal layer of Example 1 in the voltage-on state.

FIG. 5 is a graph comparing the response characteristics during switching from the voltage-off state to the voltage-on state between Example 1 and Comparative Examples 1 and 2.

FIG. 6 is a graph showing a relation between the initial alignment angle of liquid crystal molecules and the ratio of response time/transmittance in Examples 1 to 5 and Comparative Example 1.

FIG. 7 is a graph showing a relation between the slit width and the ratio of response time/transmittance.

FIG. 8 is a figure illustrating calculation results of the electric fields (lines of electric force) and the alignment distribution (alignment azimuths of liquid crystal molecules) in the liquid crystal layer of Example 7 in the voltage-on state.

FIG. 9 is a graph comparing the response characteristics during switching from the voltage-off state to the voltage-on state between Example 7 and Comparative Examples 3 and 4.

FIG. 10 is a graph showing a relation between the initial alignment angle of liquid crystal molecules and the ratio of response time/transmittance in Examples 8 to 12 and Comparative Example 3.

FIG. 11 is a schematic cross-sectional view illustrating a liquid crystal display device of Comparative Example 1 in the voltage-on state.

FIGS. 12(a) and 12(b) are schematic plan views illustrating a relation between the alignment azimuths of liquid crystal molecules and the direction of an electric field in the liquid crystal display device of Comparative Example 1. FIG. 12(a) illustrates switching from the voltage-off state to the voltage-on state, and FIG. 12(b) illustrates switching from the voltage-on state to the voltage-off state.

FIG. 13 is a schematic cross-sectional view illustrating a liquid crystal display device of Comparative Example 2 in the voltage-on state.

FIGS. 14(a) and 14(b) are schematic plan views illustrating a relation between the alignment azimuths of liquid crystal molecules and the direction of an electric field in the liquid crystal display device of Comparative Example 2. FIG. 14(a) illustrates switching from the voltage-off state to the voltage-on state, and FIG. 14(b) illustrates switching from the voltage-on state to the voltage-off state.

FIG. 15 is a figure illustrating calculation results of the electric fields (lines of electric force) and the alignment distribution (alignment azimuths of liquid crystal molecules) in the liquid crystal layer of Comparative Example 2 in the voltage-on state.

FIG. 16 is a schematic cross-sectional view illustrating a liquid crystal display device of Comparative Example 3 in the voltage-on state.

FIGS. 17(a) and 17(b) are schematic plan views illustrating a relation between the alignment azimuths of liquid crystal molecules and the direction of an electric field in the liquid crystal display device of Comparative Example 3. FIG. 17(a) illustrates switching from the voltage-off state to the voltage-on state, and FIG. 17(b) illustrates switching from the voltage-on state to the voltage-off state.

FIG. 18 is a schematic cross-sectional view illustrating a liquid crystal display device of Comparative Example 4 in the voltage-on state.

FIGS. 19(a) and 19(b) are schematic plan views illustrating a relation between the alignment azimuths of liquid crystal molecules and the direction of an electric field in the liquid crystal display device of Comparative Example 4. FIG. 19(a) illustrates switching from the voltage-off state to the voltage-on state, and FIG. 19(b) illustrates switching from the voltage-on state to the voltage-off state.

FIG. 20 is a figure illustrating calculation results of the electric fields (lines of electric force) and the alignment distribution (alignment azimuths of liquid crystal molecules) in the liquid crystal layer of Comparative Example 4 in the voltage-on state.

### DESCRIPTION OF EMBODIMENTS

The following describes an embodiment of the present invention. The present invention is not limited by the below embodiment and may have an appropriately changed design within the range that satisfies the configuration of the present invention.

In the below description, parts having the same function are given the same reference sign in different figures, and overlapping description concerning the parts is omitted.

The configurations described in the embodiment may be appropriately used in combination or modified unless the combination or the modification is beyond the spirit of the present invention.

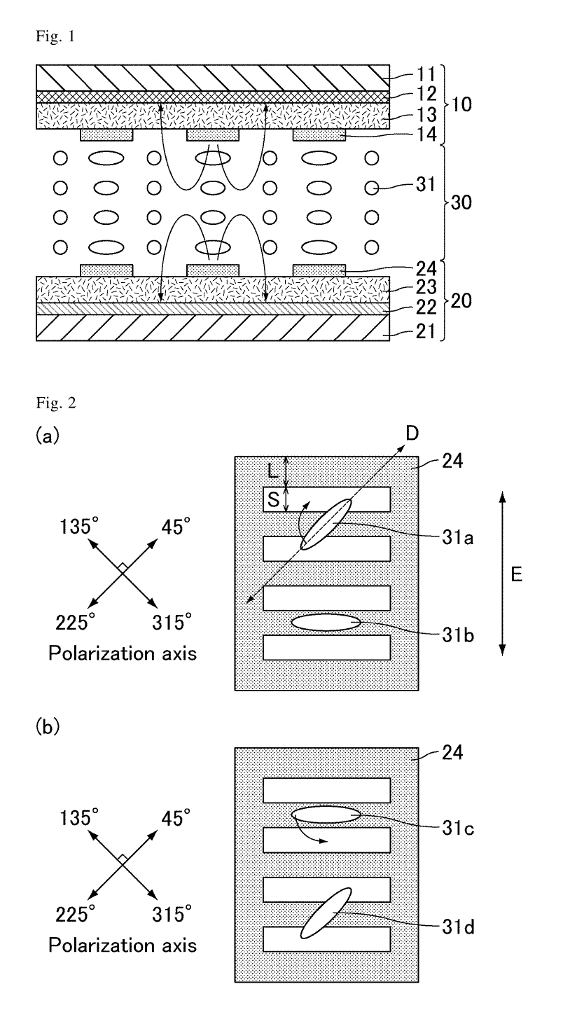

FIG. 1 is a schematic cross-sectional view illustrating a liquid crystal display device of an embodiment in the voltage-on state (a state in which voltage is applied to the liquid crystal layer). FIGS. 2(a) and 2(b) are schematic plan views illustrating a relation between the alignment azimuths of liquid crystal molecules and the direction of an electric field in the liquid crystal display device of the embodiment. FIG. 2(a) illustrates switching from the voltage-off state to the voltage-on state, and FIG. 2(b) illustrates switching from the voltage-on state to the voltage-off state.

A liquid crystal display device of the present embodiment includes: a first substrate 10 with a first fringe electric field structure; a second substrate 20 with a second fringe electric field structure; and a liquid crystal layer 30 interposed between the first substrate 10 and the second substrate 20. The first fringe electric field structure includes a first planar electrode 12, a first slit electrode 14, and a first insulating film 13 interposed between the first planar electrode 12 and the first slit electrode 14. The second fringe electric field structure includes a second planar electrode 22, a second slit electrode 24, and a second insulating film 23 interposed between the second planar electrode 22 and the second slit electrode 24. The liquid crystal layer 30 includes liquid crystal molecules 31 that align horizontally to the substrate surfaces of the first substrate 10 and the second substrate 20 with no voltage applied. The liquid crystal molecules 31 in the vicinity of the first substrate 10 and the liquid crystal molecules 31 in the vicinity of the second substrate 20 are configured to rotate in the same direction from the alignment azimuth with no voltage applied when voltage is applied to each of the first fringe electric field structure and the second fringe electric field structure.

The liquid crystal display device of the present embodiment is specifically described hereinbelow.

The first and second substrates 10 and 20 each have a fringe electric field structure. The fringe electric field structure is a structure including a planar electrode, a slit electrode, and an insulating film interposed between the planar electrode and the slit electrode, and is used to generate oblique electric fields (fringe electric fields) in the liquid crystal layer 30 adjacent to the substrates. Usually, the slit electrode, the insulating film, and the planar electrode are disposed in the stated order from the liquid crystal layer 30 side. In a conventional fringe field switching (FFS) mode, a fringe electric field structure is formed only on one of the paired substrates sandwiching the liquid crystal layer. In the present embodiment, a fringe electric field structure is formed on both of the first and second substrates 10 and 20. The fringe electric field structure on the first substrate 10 side is referred to as a “first fringe electric field structure” and the fringe electric field structure on the second substrate 20 side is referred to as a “second fringe electric field structure”. The first and second fringe electric field structures each generate oblique electric fields in the liquid crystal layer 30 so that liquid crystal molecules 31 in the entire region of the liquid crystal layer 30 can rabidly response to applied voltage. In the case of a conventional in-plain switching (IPS) mode where a pair of electrodes is disposed on the same level, liquid crystal molecules placed above the electrodes are less likely to rotate and thus respond slowly. In contrast, in the fringe electric field structure of the present embodiment, even the liquid crystal molecules 31 placed above the electrodes tend to rotate, which suitably achieves high-speed response and high transmittance.

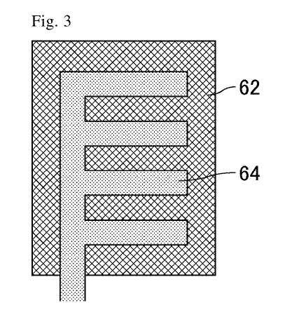

The first and second planar electrodes 12 and 22 and the first and second slit electrodes 14 and 24 of the first and second fringe electric field structures are preferably arranged in such a manner that an oblique electric field is formed for each pixel. The first and second planar electrodes 12 and 22 and/or the first and second slit electrodes 14 and 24 are preferably independently formed for each pixel. The first and second slit electrodes 14 and 24 each have a planar shape including linear apertures, i.e., slits whose peripheries are entirely surrounded by the electrode as shown in FIG. 2. Alternatively, a combination of a planar electrode 62 and a slit electrode 64 which includes a comb teeth part and linear slits formed between the comb teeth may be employed as shown in FIG. 3.

The first and second slit electrodes 14 and 24 may have any electrode width L. However, too small an electrode width L may make it difficult to accurately control the shape of the electrodes, and too large an electrode width L tends to deteriorate the response time and the transmittance. At least one of the first and second slit electrodes 14 and 24 may have an electrode width L of, for example, 2 μm or greater but 7 μm or smaller. Similarly, the first and second slit electrodes may have any slit width (electrode spacing) S. However, too small a slit width S may make it difficult to accurately control the shape of the slits, and too large a slit width S tends to deteriorate the response time and the transmittance. At least one of the first and second slit electrodes 14 and 24 has a slit width S of preferably 2 μm or greater but 7 μm or smaller, more preferably 3 μm or greater but 5 μm or smaller. In the first and second slit electrodes 14 and 24, the electrode widths L and the slit widths S are preferably constant in one pixel, but may partly have different values in one pixel. If the electrode widths L or the slit widths S are partly different in one pixel, at least 80% or more of the electrode widths L and the slit widths S preferably satisfy the preferred ranges.

Examples of the material for the first and second planar electrodes 12 and 22 and the first and second slit electrodes 14 and 24 include transparent conductive materials such as indium tin oxide (ITO) and indium zinc oxide (IZO).

The first slit electrode 14 of the first fringe electric field structure and the second slit electrode 24 of the second fringe electric field structure are each arranged in such a manner that the extending directions of the respective slits are parallel to each other. Here, the phrase “the extending directions of the respective slits are parallel to each other” means the state which allows the liquid crystal molecules 31 to rotate in a plane when voltage is applied between the first slit electrode 14 and the second slit electrode 24. The angle formed by the extending directions is, for example, preferably less than 20°, more preferably less than 10°.

The first and second insulating films 13 and 23 of the fringe electric field structures each may be an organic insulating film, an inorganic insulating film, or a laminate of these films. Examples of the insulating films include organic insulating films having a dielectric constant ε of 3 to 4 and inorganic insulating films having a dielectric constant ε of 5 to 7.

The first and second substrates 10 and 20 may be active matrix substrates (thin-film transistor (TFT) substrates) usually employed for FFS-mode liquid crystal display devices. An active matrix substrate may have a configuration including, for example, on transparent substrates 11 and 21, parallel gate signal lines; parallel source signal lines extending in the direction perpendicular to the gate signal lines; active elements such as thin film transistors (TFTs) each disposed at an intersection of a gate signal line and a source signal line; pixel electrodes (one pair of the planar electrodes 12 and 22 and the slit electrodes 14 and 24) arranged in a matrix in regions defined by the gate signal lines and the source signal lines; common wiring; counter electrodes (the other pair of the planar electrodes 12 and 22 and the slit electrodes 14 and 24) connected to the common wiring; and members such as insulating films 13 and 23 that allow insulation between the wiring and the electrodes. For providing color display, the first substrate 10 or the second substrate 20 preferably includes grid-patterned black matrix and color filters formed in the cells of the grid, namely, in the pixels. Suitably used as the TFTs are those including channels made of indium gallium zinc oxide (IGZO) which is an oxide semiconductor.

The transparent substrates 11 and 21 used for the first and second substrates 10 and 20 may be made of, for example, glass such as float glass or soda glass; or plastic such as polyethylene terephthalate, polybutylene terephthalate, polyethersulfone, polycarbonate, or an alicyclic polyolefin.

The liquid crystal layer 30 includes the liquid crystal molecules 31 that align horizontally to the substrate surfaces of the first and second substrates 10 and 20 with no voltage applied. Here, the phrase “horizontally align to the substrate surface(s)” at least means the state that the initial alignment of the liquid crystal molecules 31 is made such that the liquid crystal molecules 31 rotate in a plane when voltage is applied between the first slit electrode 14 and the second slit electrode 24. The liquid crystal molecules 31 each have a pre-tilt angle of, for example, preferably smaller than 20°, more preferably smaller than 10°. The pre-tilt angle is an inclination angle formed by the substrate surface and the major axis of each liquid crystal molecule 31. A pre-tilt angle parallel to the substrate surface is 0°, and a pre-tilt angle corresponding to the normal of the substrate surface is 90°. In order to control the pre-tilt angle, a horizontal alignment film is preferably placed on the surfaces of the first and second substrates 10 and 20 to align the liquid crystal molecules 31 in the liquid crystal layer 30 horizontally to the film surface. The horizontal alignment film may be made of an organic or inorganic material.

The liquid crystal molecules 31 may have either a negative or positive value for anisotropy of dielectric constant (As) defined by the following equation (1). In other words, the liquid crystal molecules 31 may have either negative or positive anisotropy of dielectric constant. The liquid crystal molecules 31 with negative anisotropy of dielectric constant may have an anisotropy of dielectric constant Δε of −1 to −20, for example. The liquid crystal molecules 31 with positive anisotropy of dielectric constant may have an anisotropy of dielectric constant Δε of 1 to 20, for example. Δε= (dielectric constant in the major axis direction)-(dielectric constant in the minor axis direction) (1)

The first and second substrates 10 and 20 are usually attached to each other with a sealing material applied so as to surround the periphery of the liquid crystal layer 30 so that the liquid crystal layer 30 is fixed in a predetermined region by the first substrate 10, the second substrate 20, and the sealing material. The sealing material may be an epoxy resin including a curing agent and an inorganic or organic filler, for example.

The first and second substrates 10 and 20 may each have a polarizer (linear polarizer) on the side opposite to the liquid crystal layer 30. Typical examples of the polarizer include those obtained by aligning a dichroic anisotropic material such as iodine complex absorbed on a polyvinyl alcohol (PVA) film. Usually, a laminate including a PVA film sandwiched between protect films such as triacetylcellulose films is practically used. An optical film such as a retardation film may be disposed between the polarizer and the first substrate 10 or the second substrate 20.

In the liquid crystal display device, when the voltage applied to the liquid crystal layer 30 interposed between the first substrate 10 and the second substrate 20 is less than the threshold voltage (including the case where no voltage is applied), the alignment film mainly functions to align the liquid crystal molecules 31 in the liquid crystal layer 30 horizontally to the substrate surfaces of the first substrate 10 and the second substrate 20. In contrast, when a voltage not less than the threshold voltage is applied to the liquid crystal layer 30 interposed between the first substrate 10 and the second substrate 20 by the first fringe electric field structure and the second fringe electric field structure, the alignment of the liquid crystal molecules 31 is changed depending on the strength of the electric fields to control the polarization of the polarized light permeating the liquid crystal layer 30.

In the present embodiment, the initial alignment of the liquid crystal molecules 31 and the extending direction of each slit are arranged in such a manner that the liquid crystal molecules 31 in the vicinity of the first substrate 10 and the liquid crystal molecules 31 in the vicinity of the second substrate 20 rotate in the same direction from the alignment azimuth with no voltage applied when voltage is applied to each of the first fringe electric field structure and the second fringe electric field structure. The phrase “the liquid crystal molecules 31 in the vicinity of the first substrate 10” means at least part of the liquid crystal molecules 31 in a region closer to the first substrate 10 than to the second substrate 20 in the thickness direction of the liquid crystal layer 30. The phrase “the liquid crystal molecules 31 in the vicinity of the second substrate 20” means at least part of the liquid crystal molecules 31 in a region closer to the second substrate 20 than to the first substrate 10 in the thickness direction of the liquid crystal layer 30. The phrase “rotate in the same direction” means that, in a plan view from the normal direction of the substrate surface of the first substrate 10 or the second substrate 20, if the liquid crystal molecules 31 in the vicinity of the first substrate 10 rotate to the right, the liquid crystal molecules 31 in the vicinity of the second substrate 20 also rotate to the right, and if the liquid crystal molecules 31 in the vicinity of the first substrate 10 rotate to the left, the liquid crystal molecules 31 in the vicinity of the second substrate 20 also rotate to the left. The rotation direction of the liquid crystal molecules 31 when observed from the display surface side of the liquid crystal display device is opposite to that when observed from the back surface side thereof. The rotation direction of the liquid crystal molecules 31 in the vicinity of the first substrate 10 and the rotation direction of the liquid crystal molecules 31 in the vicinity of the second substrate 20 are determined by observing the liquid crystal display device from the same point (either the display surface side or the back surface side of the liquid crystal display device). The above arrangement enables high transmittance in the present embodiment.

When the liquid crystal molecules 31 have negative anisotropy of dielectric constant, the major axis direction of the liquid crystal molecules 31 with no voltage applied forms an angle of preferably 35° or larger but 70° or smaller, more preferably 45° or larger but 60° or smaller, with the extending direction of each slit formed on the first and second slit electrodes 14 and 24. When the liquid crystal molecules 31 have positive anisotropy of dielectric constant, the major axis direction of the liquid crystal molecules 31 with no voltage applied forms an angle of preferably 50° or smaller, more preferably 5° or larger but 45° or smaller, with the extending direction of each slit formed on the first and second slit electrodes 14 and 24. The liquid crystal molecules 31 preferably have the same initial alignment between in the vicinity of the first substrate 10 and in the vicinity of the second substrate 20. The initial alignment of the liquid crystal molecules 31 may be controlled by photoalignment treatment or rubbing treatment of the alignment film, for example.

The liquid crystal display device is assembled from multiple members including: a liquid crystal display panel; an external circuit such as a tape carrier package (TCP) or a PCB (printed circuit board); an optical film such as a film for wide viewing angle or a brightness enhancement film; a backlight unit; and a bezel (frame). Some of the members may be appropriately incorporated into other member(s). Members other than those described hereinabove may be any members commonly used in the field of liquid crystal display devices, and thus the description of the members is omitted.

Although the above description relates to the embodiment of the present invention, all the described matters may be applied to the whole range of the present invention.

### EXAMPLES

The present invention is more specifically described with reference to examples, which do not intend to limit the present invention, and comparative examples.

### Example 1

A liquid crystal display device of Example 1 belongs to the above embodiment and has the following specific configuration and the structure as shown in FIG. 1. In the present description, a pair of substrates (the combination of the first substrate 10 and the second substrate 20) sandwiching a liquid crystal layer are collectively referred to as “upper and lower substrates”. The substrate on the display surface side (the first substrate 10 in FIG. 1) is also referred to as “an upper substrate”, and the substrate on the back surface side (the second substrate 20 in FIG. 1) is also referred to as “a lower substrate”.

The upper and lower substrates 10 and 20 each have a fringe electric field structure (FFS structure). Each FFS structure includes a pixel electrode (first or second slit electrode) 14 or 24 adjacent to the liquid crystal layer 30 with an alignment film in between, a counter electrode (first or second planar electrode) 12 or 22, and an inorganic insulating film (first insulating film) 13 satisfying ε−6.9 between the pixel electrode 14 and the counter electrode 12 or an inorganic insulating film (second insulating film) 23 satisfying ε=6.9 between the pixel electrode 24 and the counter electrode 22. The pixel electrodes 14 and 24 have slits, and the electrode width L (line) and the slit width S (space) are each 3 μm. The counter electrodes 12 and 22 are solid electrodes (planar electrodes).

The initial alignment of the liquid crystal molecules 31 included in the liquid crystal layer 30 is horizontal alignment (parallel alignment), and the alignment azimuth (the alignment direction in a plane) is designed to form an angle of 45° with the extending direction of the parallel slits of the pixel electrodes 14 and 24 on the upper and lower substrates 10 and 20. The liquid crystal molecules 31 have an anisotropy of dielectric constant εε of −3.6 and a refractive index anisotropy Δn of 0.1. The liquid crystal panel has an in-plane retardation Re of 320 nm. The liquid crystal layer 30 has a thickness of 3.2 μm and a viscosity of 120 cps.

In the present example, fringe electric fields are simultaneously generated by the FFS structures of the upper and lower substrates 10 and 20 to rotate the liquid crystal molecules 31 in the entire region of the liquid crystal layer 30 so that optical modulation is performed from a low gray scale value to a high gray scale value. Optical modulation from a high gray scale value to a low gray scale value is performed by simultaneously switching off the voltages applied to the FFS structures of the upper and lower substrates 10 and 20. In the present example, a voltage of 6 V is applied to the pixel electrode 24 for providing white display

The behavior of the liquid crystal molecules 31 in the voltage-on state and voltage-off state is described with reference to an electric field direction E in FIG. 2. FIG. 2(a) illustrates switching from the voltage-off state to the voltage-on state. FIG. 2(a) includes a liquid crystal molecule 31a showing the alignment state of the liquid crystal molecules 31 in the voltage-off state and a liquid crystal molecule 31b showing the alignment state of the liquid crystal molecules 31 in the voltage-on state. The alignment azimuth (initial alignment azimuth) D of the liquid crystal molecule 31a is designed to form an angle of 45° with the extending direction of the slits of the pixel electrodes 14 and 24 on the upper and lower substrates 10 and 20. In the liquid crystal display device of the present example, a pair of polarizers are disposed in crossed Nicols, namely, one is parallel to the initial alignment azimuth D of the liquid crystal molecule 31a and the other is perpendicular thereto, which constitutes a normally black mode (a mode providing black display in the voltage-off state). In the switching from the voltage-off state to the voltage-on state, in each of the upper and lower substrates 10 and 20, voltage is applied between the pixel electrode 14 or 24 on the liquid crystal layer 30 side and the planer counter electrode 12 or 22 on the side opposite to the liquid crystal layer 30 to generate fringe electric fields in the liquid crystal layer 30. The liquid crystal molecule 31a, which is aligned with the initial alignment azimuth D and has negative anisotropy of dielectric constant, rotates in the direction indicated by the arrow in FIG. 2(a) (clockwise) to be aligned as shown by the liquid crystal molecule 31b that is perpendicular to the direction of the electric field E of the fringe electric field. As described above, the liquid crystal molecules 31a in the vicinity of the upper and lower substrates 10 and 20 are rotated in the same direction by the pixel electrodes 14 and 24 and the counter electrodes 12 and 22 disposed on the upper and lower substrates 10 and 20 to allow for optical modulation from a low gray scale value to a high gray scale value so that high transmittance is achieved.

FIG. 2(b) illustrates switching from the voltage-on state to the voltage-off state. FIG. 2(b) includes a liquid crystal molecule 31c showing the alignment state of the liquid crystal molecules 31 in the voltage-on state and a liquid crystal molecule 31d showing the alignment state of the liquid crystal molecules 31 in the voltage-off state. In the switching from the voltage-on state to the voltage-off state, the voltages applied to the pixel electrodes 14 and 24 and the counter electrodes 12 and 22 is lost to allow the fringe electric fields to disappear so that the liquid crystal molecule 31c rotates in the direction indicated by the arrow in FIG. 2(b) (counterclockwise) back to the initial alignment azimuth (anchoring alignment azimuth) D by the elastic constant and viscosity of the liquid crystal.

The liquid crystal display device of the present example can achieve high-speed response and high transmittance. The reason for this is as follows.

In conventional FFS modes, electric fields formed on only one of the upper and lower substrates rotate liquid crystal in the entire region of the liquid crystal layer. Thus, the strength of electric fields affecting the liquid crystal molecules in the vicinity of the other substrate is weak, whereby the liquid crystal at this region rotates slowly. In contrast, in the present example, electric fields are formed on both of the upper and lower substrates 10 and 20 so that strong electric fields can be entirely applied in the liquid crystal layer 30. This configuration enables rabid rotation of the liquid crystal molecules 31 in the entire region of the liquid crystal layer 30 to achieve high-speed response.

Also, in conventional FFS modes, while liquid crystal molecules in the vicinity of one substrate with an FFS structure greatly rotate, liquid crystal molecules in the vicinity of the other substrate without an FFS structure have smaller rotation angles because electric fields become weaker as coming closer to the other substrate. Thus, liquid crystal molecules in the vicinity of the other substrate less contribute to optical modulation. In contrast, in the present example, fringe electric fields are generated on both of the upper and lower substrates 10 and 20 so that the liquid crystal molecules 31 in the vicinity of the upper and lower substrates 10 and 20 can greatly rotate. Here, by rotating the liquid crystal molecules 31 in the vicinity of the lower substrate 20 and the liquid crystal molecules 31 in the vicinity of the upper substrate 10 in the same direction, the liquid crystal molecules 31 placed in the middle between the upper and lower substrates 10 and 20 can also greatly rotate so that the liquid crystal molecules 31 in the entire region of the liquid crystal layer 30 can greatly rotate. As a result, the liquid crystal molecules 31 in the entire region of the liquid crystal layer 30 contribute to optical modulation to achieve high transmittance. If the rotation direction of the liquid crystal molecules 31 in the vicinity of the lower substrate 20 is opposite to that in the vicinity of the upper substrate 10, the liquid crystal molecules 31 placed in the middle cannot rotate and contribute to optical modulation, thereby failing to achieve high transmittance.

### Comparative Example 1

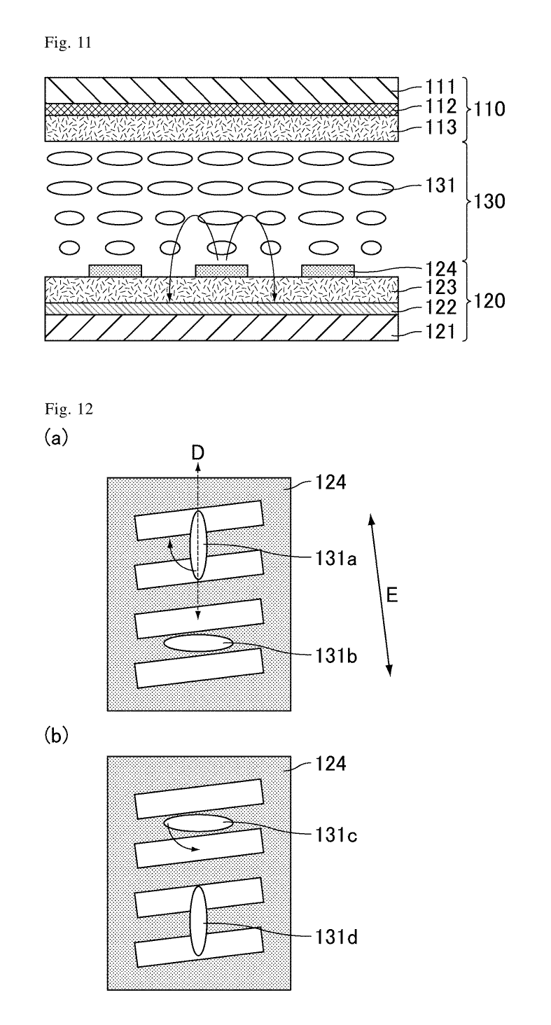

FIG. 11 is a schematic cross-sectional view illustrating a liquid crystal display device of Comparative Example 1 in the voltage-on state. FIGS. 12(a) and 12(b) are schematic plan views illustrating a relation between the alignment azimuths of liquid crystal molecules and the direction of an electric field in the liquid crystal display device of Comparative Example 1. FIG. 12(a) illustrates switching from the voltage-off state to the voltage-on state, and FIG. 12(b) illustrates switching from the voltage-on state to the voltage-off state.

In Comparative Example 1, the same FFS structure as in Example 1 is provided only on a lower substrate 120. The pixel electrode 124 has an electrode width (line) of 3 μm and a slit width (space) of 3 μm.

The initial alignment of the liquid crystal molecules 131 is horizontal alignment (parallel alignment), and the alignment azimuth is designed to form an angle of 83° with the extending direction of each slit of the pixel electrode 124. The anisotropy of dielectric constant Δε and the refractive index anisotropy Δn of the liquid crystal molecules 131, the in-plane retardation Re of the liquid crystal panel, and the thickness and the viscosity of the liquid crystal layer 130 are the same as those in Example 1.

FIG. 12(a) illustrates switching from the voltage-off state to the voltage-on state. FIG. 12(a) includes a liquid crystal molecule 131a showing the alignment state of the liquid crystal molecules 131 in the voltage-off state and a liquid crystal molecule 131b showing the alignment state of the liquid crystal molecules 131 in the voltage-on state. When voltage is applied to the pixel electrode 124, fringe electric fields are generated by the pixel electrode 124 on the liquid crystal layer 130 side and a counter electrode 122 on the side opposite to the liquid crystal layer 130. Here, the liquid crystal molecule 131a rotates from the initial alignment azimuth (clockwise in FIG. 12(a)) to perform optical modulation from a low gray scale value to a high gray scale value. In the present comparative example, a voltage of 6 V is applied to the pixel electrode 124 for providing white display.

FIG. 12(b) illustrates switching from the voltage-on state to the voltage-off state. FIG. 12(b) includes a liquid crystal molecule 131c showing the alignment state of the liquid crystal molecules 131 in the voltage-on state and a liquid crystal molecule 131d showing the alignment state of the liquid crystal molecules 131 in the voltage-off state. In the switching from the voltage-on state to the voltage-off state, the voltages applied to the electrodes 122 and 124 is lost to allow the fringe electric fields to disappear so that the liquid crystal molecules rotate back to the initial alignment azimuth (anchoring alignment azimuth) D by the elastic constant and viscosity of the liquid crystal.

### Comparative Example 2

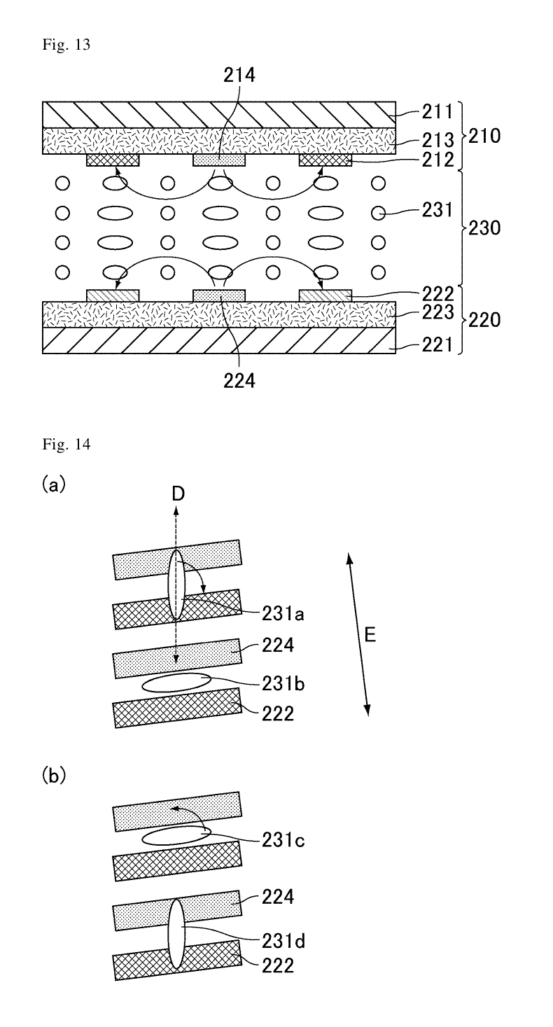

FIG. 13 is a schematic cross-sectional view illustrating a liquid crystal display device of Comparative Example 2 in the voltage-on state. FIGS. 14(a) and 14(b) are schematic plan views illustrating a relation between the alignment azimuths of liquid crystal molecules and the direction of an electric field in the liquid crystal display device of Comparative Example 2. FIG. 14(a) illustrates switching from the voltage-off state to the voltage-on state, and FIG. 14(b) illustrates switching from the voltage-on state to the voltage-off state.

The liquid crystal display device of Comparative Example 2 is produced with reference to the panel structure disclosed in Patent Literature 1. A common electrode 212 and a pixel electrode 214 formed on an upper substrate 210 and a common electrode 222 and a pixel electrode 224 formed on a lower substrate 220 each have a comb shape. The common electrode 212 and the pixel electrode 214 are arranged in such a manner that the comb teeth parts of the respective electrodes mesh with each other. Similarly, the common electrode 222 and the pixel electrode 224 are arranged in such a manner that the comb teeth parts of the respective electrodes mesh with each other. Each electrode has an electrode width (line) of 7 μm and a slit width (space) of 10 μm. The common electrode 212 and the pixel electrode 214 are both formed on the surface of an inorganic insulating film 213 satisfying ε=6.9. The common electrode 222 and the pixel electrode 224 are both formed on the surface of an inorganic insulating film 223 satisfying ε=6.9. Although FIG. 14 shows a simple view focusing only on the comb teeth part of the common electrode 222 and the comb teeth part of the pixel electrode 224, the teeth in the comb teeth part of the common electrode 222 are electrically connected to each other via a trunk portion, and the teeth in the comb teeth part of the pixel electrode 224 are electrically connected to each other via a trunk portion. Also, the common electrodes 212 and 222 and the pixel electrodes 214 and 224 formed on the upper and lower substrates 210 and 220 are each electrically connected.

The initial alignment of the liquid crystal molecules 231 is horizontal alignment (parallel alignment), and the alignment azimuth is designed to form an angle of 83° with the extending direction of the slits of the common electrodes 212 and 222 and the pixel electrodes 214 and 224. The anisotropy of dielectric constant A and the refractive index anisotropy An of the liquid crystal molecules 231, the in-plane retardation Re of the liquid crystal panel, and the thickness and the viscosity of the liquid crystal layer 230 are the same as those in Example 1.

FIG. 14(a) illustrates switching from the voltage-off state to the voltage-on state. FIG. 14(a) includes a liquid crystal molecule 231a showing the alignment state of the liquid crystal molecules 231 in the voltage-off state and a liquid crystal molecule 231b showing the alignment state of the liquid crystal molecules 231 in the voltage-on state. FIG. 14(a) illustrates the electrode structure of the lower substrate 220, and the same electrode structure is provided on the upper substrate 210. When voltage is applied to the pixel electrode 224, transverse electric fields are generated between the pixel electrode 224 and the common electrode 222. Here, the liquid crystal molecules 231 rotate along the transverse electric fields to perform optical modulation from a low gray scale value to a high gray scale value. In the present comparative example, a voltage of 6 V is applied to the pixel electrodes 214 and 224 for providing white display.

FIG. 14(b) illustrates switching from the voltage-on state to the voltage-off state. FIG. 14(b) includes a liquid crystal molecule 231c showing the alignment state of the liquid crystal molecules 231 in the voltage-on state and a liquid crystal molecule 231d showing the alignment state of the liquid crystal molecules 231 in the voltage-off state. In the switching from the voltage-on state to the voltage-off state, the voltage having been applied to the electrodes is lost to allow the transverse electric fields disappear so that the liquid crystal molecules rotate back to the initial alignment azimuth (anchoring alignment azimuth) D by the elastic constant and the viscosity of the liquid crystal.

### Evaluation for Example 1 and Comparative Examples 1 and 2

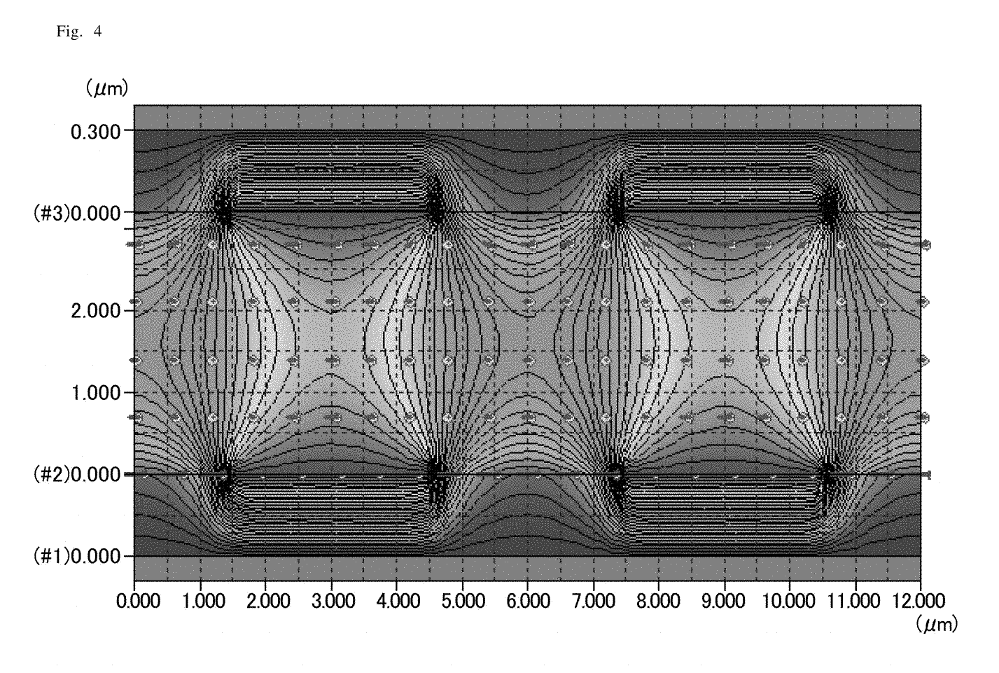

The liquid crystal display devices of Example 1 and Comparative Examples 1 and 2 were evaluated for optical response performance by simulating the alignment azimuths of liquid crystal molecules with an LCD-Master 2D available from Shintec Co., Ltd. FIGS. 4, 5, and 15 show the results.

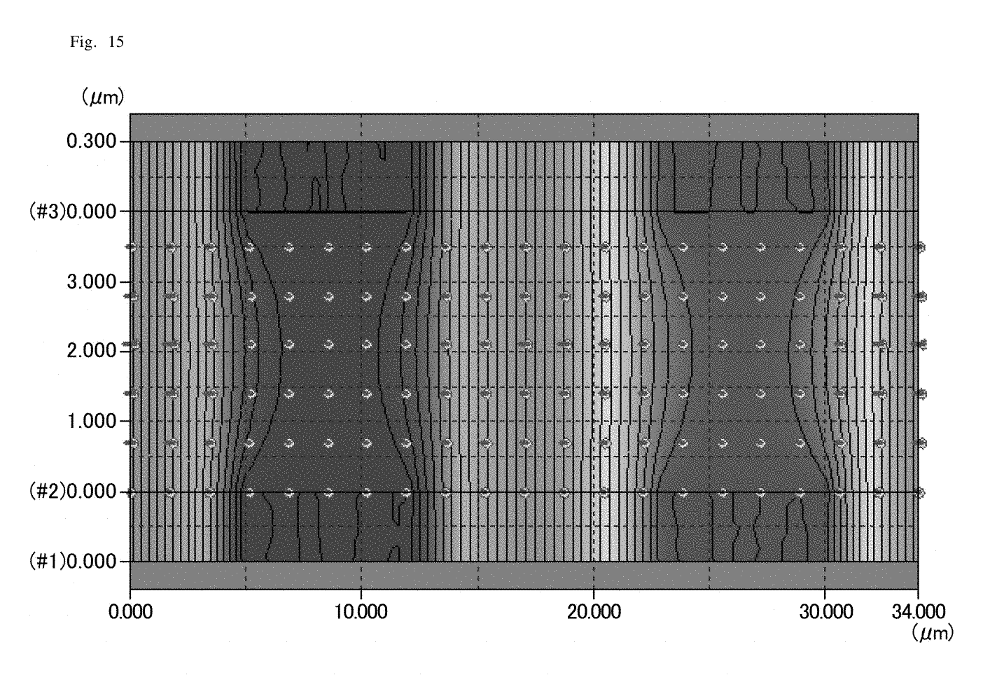

FIG. 4 is a figure illustrating calculation results of the electric fields (lines of electric force) and the alignment distribution (alignment azimuths of liquid crystal molecules) in the liquid crystal layer of Example 1 in the voltage-on state. FIG. 15 is a figure illustrating calculation results of the electric fields (lines of electric force) and the alignment distribution (alignment azimuths of liquid crystal molecules) in the liquid crystal layer of Comparative Example 2 in the voltage-on state. On the vertical axis in FIG. 4, #1 indicates the position of the planar counter electrode 22, #2 indicates the position of the pixel electrode 24, and #3 indicates the position of the pixel electrode 14. The inorganic insulating film 23 is interposed between #1 and #2, and the liquid crystal layer 30 is interposed between #2 and #3. On the vertical axis in FIG. 15, #2 indicates the position of the common electrode 222 and the pixel electrode 224, and #3 indicates the position of the common electrode 212 and the pixel electrode 214. The inorganic insulating film 223 is interposed between #1 and #2, and the liquid crystal layer 230 is interposed between #2 and #3. In FIG. 4 and FIG. 15, the alignment of each liquid crystal molecule in the liquid crystal layer is depicted by the direction and length of a line representing the liquid crystal molecule.

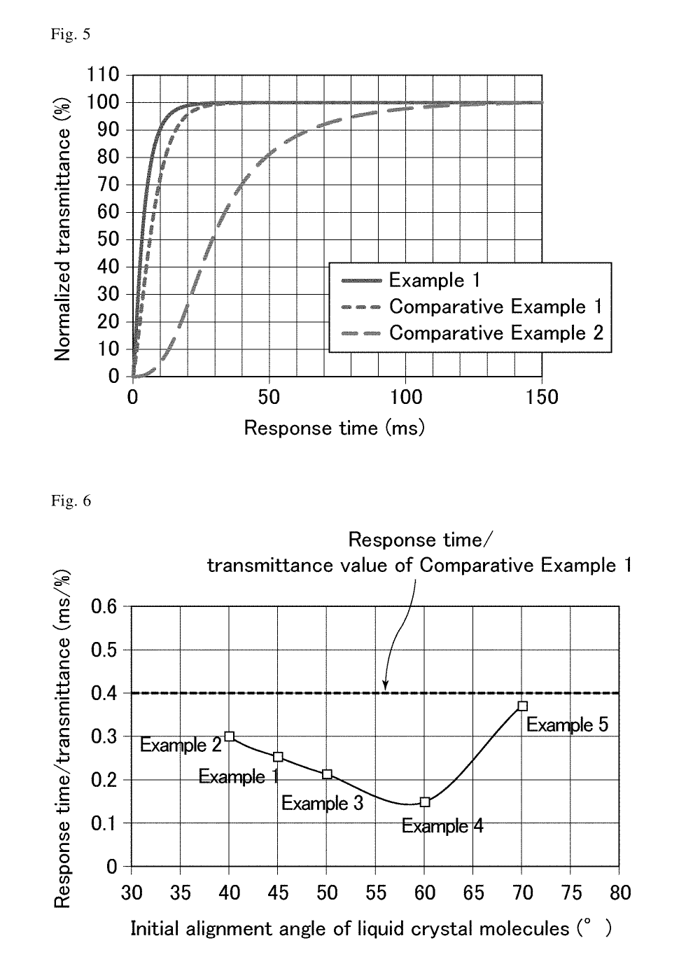

FIG. 5 is a graph comparing the response characteristics during switching from the voltage-off state to the voltage-on state between Example 1 and Comparative Examples 1 and 2.

Table 1 shows evaluation parameters and the results relating to the response characteristics.

TABLE 1

| | | Comparative | Comparative |
|---|---|---|---|
| | Example 1 | Example 1 | Example 2 |
| Initial alignment (°) | 45 | 83 | 83 |
| against the electrode (slit) | | | |
| Anisotropy of dielectric constant | negative | negative | negative |
| of liquid crystal | | | |
| Electrode width L/Slit width | 3/3 | 3/3 | 7/10 |
| S (μm) | | | |
| T10% to T90% response time | 9.1 | 14.2 | 51.2 |
| (ms) | | | |

The parameter “T10% to T90% response time” in the table indicates a time period required for increasing the relative transmittance (normalized transmittance) from 10% to 90% when the maximum transmittance of each example is defined as 100%.

The results shown in Table 1 and FIG. 5 demonstrate that the response time of Example 1 is shorter than that of Comparative Examples 1 and 2. The reason for this is as follows. In Comparative Example 1 which employs a common FFS mode, the liquid crystal is rotated only by the fringe electric fields of the lower substrate. In contrast, in Example 1, the liquid crystal is rotated by the fringe electric fields of both of the upper and lower substrates so that the liquid crystal molecules in the entire region of the liquid crystal layer can rotate faster. The reason that the Comparative Example 2 fails to achieve high-speed response in spite that the liquid crystal molecules are rotated by the transverse electric fields of both of the upper and lower substrates is as follows. Since Comparative Example 2 employs an IPS electrode structure to generate transverse electric fields, the liquid crystal molecules between the electrodes have an equal potential in the thickness direction of the liquid crystal layer as shown in FIG. 15 so that liquid crystal molecules above the electrodes are less likely to rotate.

### Examples 2 to 5

Liquid crystal display devices of Examples 2 to 5 have the same configuration as that of Example 1 except that the angle formed by the initial alignment of liquid crystal molecules and the extending direction of the slits of the pixel electrodes (also referred to as “initial alignment angle of liquid crystal molecules”) is changed as shown in the below Table 2.

Table 2 shows: (A) the angle formed by the initial alignment of liquid crystal molecules and the extending direction of the slits of the pixel electrodes, (B) the T10% to T90% response time, (C) the transmittance of white display, and (D) the value obtained by dividing the T10% to T90% response time (ms) by the transmittance (%) (response time/transmittance), of the liquid crystal display devices of Examples 1 to 5 and Comparative Example 1. The transmittance of white display indicates the proportion of a light component transmitted through the display surface of the liquid crystal display device in the white display state among the light components emitted by the backlight.

TABLE 2

| | | Response | Trans- | Response time/ |
|---|---|---|---|---|
| | Angle | time | mittance | Transmittance |
| | (°) | (ms) | (%) | (ms/%) |
| Example 1 | 45 | 9.1 | 35.9 | 0.253 |
| Example 2 | 40 | 9.8 | 32.6 | 0.301 |
| Example 3 | 50 | 8.1 | 37.9 | 0.214 |
| Example 4 | 60 | 5.6 | 37.5 | 0.149 |
| Example 5 | 70 | 14.2 | 38.4 | 0.370 |
| Comparative | 83 | 14.3 | 36.1 | 0.396 |
| Example 1 | | | | |

FIG. 6 is a graph showing a relation between the initial alignment angle of liquid crystal molecules and the ratio of response time/transmittance in Examples 1 to 5 and Comparative Example 1. The values of Examples 1 to 5 were plotted in the graph where the initial alignment angle of liquid crystal molecules is represented by the horizontal axis and the ratio of response time/transmittance is represented by the vertical axis. As shown in FIG. 6, when liquid crystal molecules having negative anisotropy of dielectric constant are used in the novel display mode of the present invention, the initial alignment angle of the liquid crystal molecules is preferably 35° or larger, more preferably 45° or larger, still more preferably 55° or larger, while preferably 70° or smaller, more preferably 65° or smaller, still more preferably 60° or smaller.

### Example 6

A liquid crystal display device of Example 6 has the same configuration as that of Example 1 except that the slit width of the pixel electrodes on the upper and lower substrates was changed as shown in Table 3. The electrode width was fixed to 3 μm because a larger electrode width tends to deteriorate the response time and the transmittance.

Table 3 shows: (A) the slit width of the pixel electrodes, (B) the T10% to T90% response time, (C) the transmittance of white display, and (D) the value obtained by dividing the T10% to T90% response time (ms) by the transmittance (%) (response time/transmittance), of the liquid crystal display devices of Examples 1 and 6 and Comparative Example 1.

TABLE 3

| | | Response | Trans- | Response time/ |
|---|---|---|---|---|
| | Slit width | time | mittance | Transmittance |
| | (μm) | (ms) | (%) | (ms/%) |
| Example 1 | 3 | 9.1 | 35.9 | 0.253 |
| Example 6 | 6 | 11.4 | 33.7 | 0.339 |
| Comparative | 3 | 14.3 | 36.1 | 0.396 |
| Example 1 | | | | |

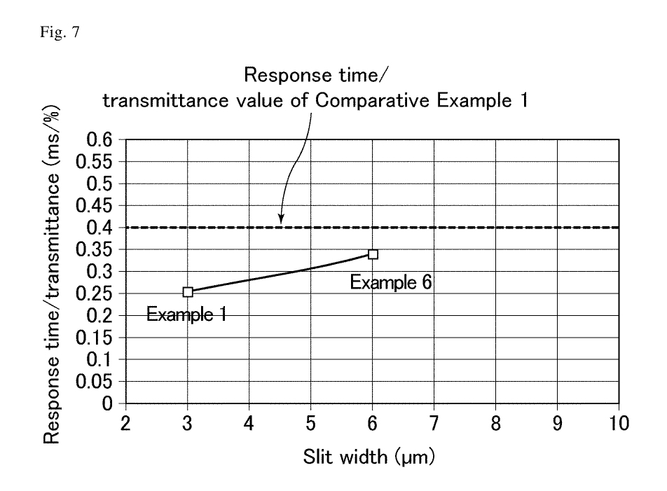

FIG. 7 is a graph showing a relation between the slit width and the ratio of response time/transmittance. The values of Examples 1 and 6 were plotted in the graph where the slit width was represented by the horizontal axis and the ratio of response time/transmittance was represented by the vertical axis. As shown in FIG. 7, in the novel display mode of the present invention, the slit width is preferably within the range of 3 μm to 7 μm.

### Example 7

A liquid crystal display device of Example 7 has the same configuration as that of Example 1 except that liquid crystal molecules having positive anisotropy of dielectric constant (Δε=3.6) were used. The initial alignment azimuths of liquid crystal molecules is designed to form an angle of 45° with the extending direction of the parallel slits of the pixel electrodes in the upper and lower substrates. The liquid crystal material has an anisotropy of dielectric constant value whose sign is opposite to the value of Example 1, and the other physical property values are the same as in Example 1.

### Comparative Example 3

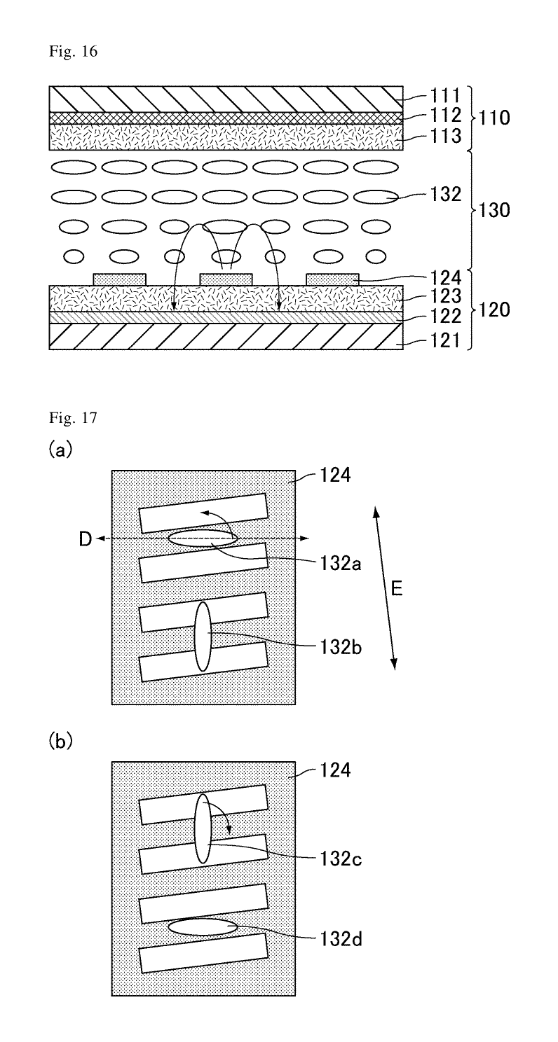

FIG. 16 is a schematic cross-sectional view illustrating a liquid crystal display device of Comparative Example 3 in the voltage-on state. FIGS. 17(a) and 17(b) are schematic plan views illustrating a relation between the alignment azimuths of liquid crystal molecules and the direction of an electric field in the liquid crystal display device of Comparative Example 3. FIG. 17(a) illustrates switching from the voltage-off state to the voltage-on state, and FIG. 17(b) illustrates switching from the voltage-on state to the voltage-off state. FIG. 17(a) includes a liquid crystal molecule 132a showing the alignment state of the liquid crystal molecules 132 in the voltage-off state and a liquid crystal molecule 132b showing the alignment state of the liquid crystal molecules 132 in the voltage-on state. FIG. 17(b) includes a liquid crystal molecule 132c showing the alignment state of the liquid crystal molecules 132 in the voltage-on state and a liquid crystal molecule 132d showing the alignment state of the liquid crystal molecules 132 in the voltage-off state.

The liquid crystal display device of Comparative Example 3 has the same configuration as that of Comparative Example 1 except that the liquid crystal molecules 132 have positive anisotropy of dielectric constant (Δε=3.6) and an initial alignment angle of 7°. The same FFS structure as in Example 1 is provided only on the lower substrate 120. The pixel electrode 124 has an electrode width (line) of 3 μm and a slit width (space) of 3 μm. The initial alignment azimuth of the liquid crystal molecules is designed to form an angle of 7° with the extending direction of the parallel slits of the pixel electrode 124 in the upper and lower substrates 110 and 210. The liquid crystal material has an anisotropy of dielectric constant value whose sign is opposite to the value of Example 1, and the other physical property values are the same as in Example 1.

### Comparative Example 4

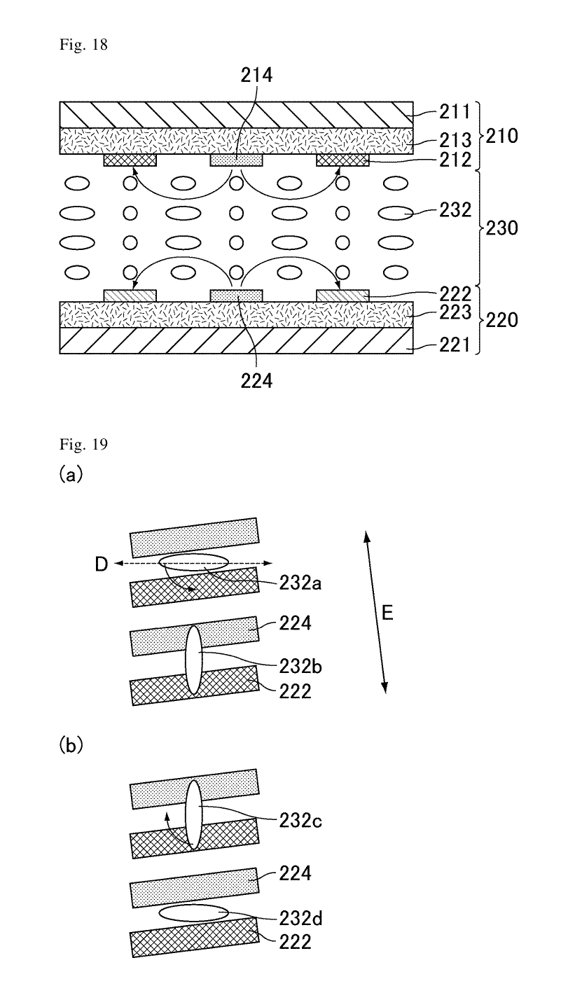

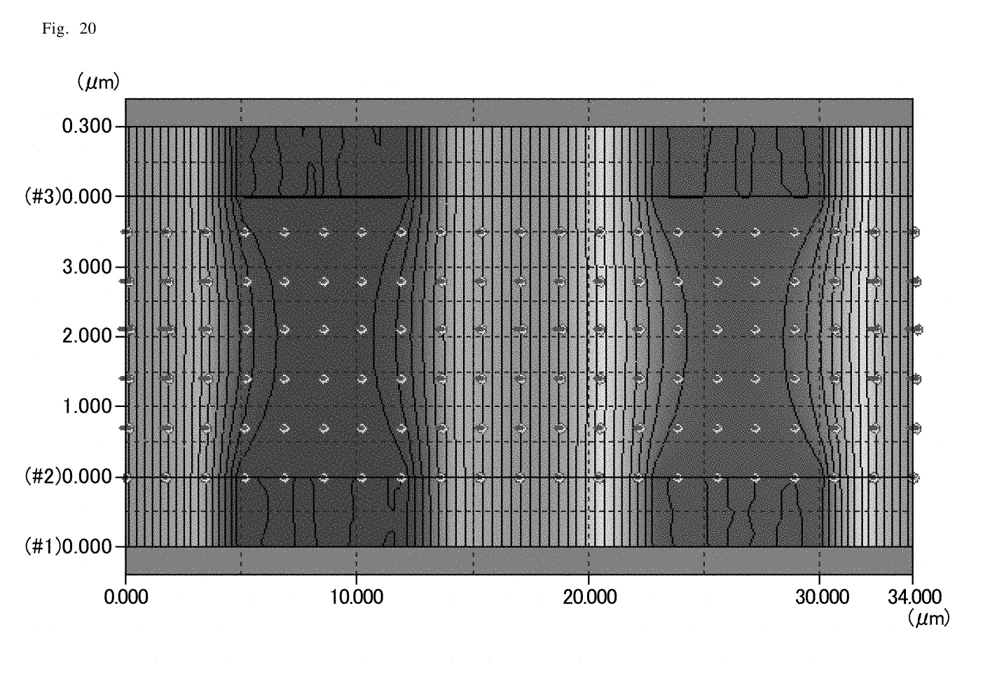

FIG. 18 is a schematic cross-sectional view illustrating a liquid crystal display device of Comparative Example 4 in the voltage-on state. FIGS. 19(a) and 19(b) are schematic plan views illustrating a relation between the alignment azimuths of liquid crystal molecules and the direction of an electric field in the liquid crystal display device of Comparative Example 4. FIG. 19(a) illustrates switching from the voltage-off state to the voltage-on state, and FIG. 19(b) illustrates switching from the voltage-on state to the voltage-off state. FIG. 19(a) includes a liquid crystal molecule 232a showing the alignment state of the liquid crystal molecules 232 in the voltage-off state and a liquid crystal molecule 232b showing the alignment state of the liquid crystal molecules 232 in the voltage-on state. FIG. 19(b) includes a liquid crystal molecule 232c showing the alignment state of the liquid crystal molecules 232 in the voltage-on state and a liquid crystal molecule 232d showing the alignment state of the liquid crystal molecules 232 in the voltage-off state.

The liquid crystal display device of Comparative Example 4 has the same configuration as that of Comparative Example 2 except that the liquid crystal molecules 232 have positive anisotropy of dielectric constant (Δε=3.6) and an initial alignment angle of 7°. The liquid crystal display device of Comparative Example 4 is produced with reference to the panel structure disclosed in Patent Literature 1. The common electrode 212 and the pixel electrode 214 formed on the upper substrate 210 and the common electrode 222 and the pixel electrode 224 formed on the lower substrate 220 each have a comb shape. The common electrode 212 and the pixel electrode 214 are arranged in such a manner that the comb teeth parts of the respective electrodes mesh with each other. Similarly, the common electrode 222 and the pixel electrode 224 are arranged in such a manner that the comb teeth parts of the respective electrodes mesh with each other. Each electrode has an electrode width (line) of 7 μm and a slit width (space) of 10 μm. Although FIG. 19 shows a simple view focusing only on the comb teeth parts of the common electrode 222 and the comb teeth part of the pixel electrode 224, the teeth in the comb teeth part of the common electrode 222 and the teeth in the comb teeth part of the pixel electrode 224 are each electrically connected to a trunk portion. Also, the common electrodes 212 and 222 and the pixel electrodes 214 and 224 formed on the upper and lower substrates 210 and 220 are each electrically connected. The initial alignment azimuth D of the liquid crystal molecules 232 is designed to form an angle of 7° with the extending direction of the parallel slits of the pixel electrodes 214 and 224 in the upper and lower substrates 210 and 220. The liquid crystal material has an anisotropy of dielectric constant value whose sign is opposite to the value of Example 1, and the other physical property values are the same as in Example 1.

### Evaluation for Example 7 and Comparative Examples 3 and 4

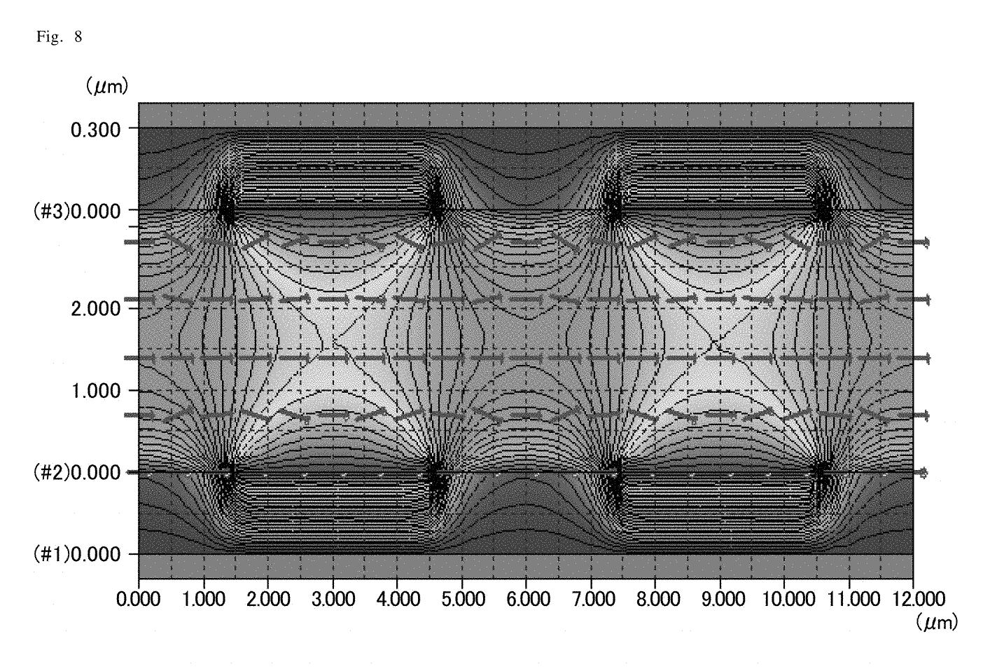

The liquid crystal display devices of Example 7 and Comparative Examples 3 and 4 were evaluated for optical response performance by simulating the alignment azimuths of liquid crystal molecules with an LCD-Master 2D available from Shintec Co., Ltd. FIGS. 8, 9, and 20 show the results.

FIG. 8 is a figure illustrating calculation results of the electric fields (lines of electric force) and the alignment distribution (alignment azimuths of liquid crystal molecules) in the liquid crystal layer of Example 7 in the voltage-on state. FIG. 20 is a figure illustrating calculation results of the electric fields (lines of electric force) and the alignment distribution (alignment azimuths of liquid crystal molecules) in the liquid crystal layer of Comparative Example 4 in the voltage-on state. On the vertical axis in FIG. 8, #1 indicates the position of the planar counter electrode 22, #2 indicates the position of the pixel electrode 24, and #3 indicates the position of the pixel electrode 14. The inorganic insulating film 23 is interposed between #1 and #2, and the liquid crystal layer 30 is interposed between #2 and #3. On the vertical axis in FIG. 20, #2 indicates the position of the common electrode 222 and the pixel electrode 224, and #3 indicates the position of the common electrode 212 and the pixel electrode 214. The inorganic insulating film 223 is interposed between #1 and #2, and the liquid crystal layer 230 is interposed between #2 and #3. In FIG. 8 and FIG. 20, the alignment of each liquid crystal molecule in the liquid crystal layer is depicted by the direction and length of a line representing the liquid crystal molecule.

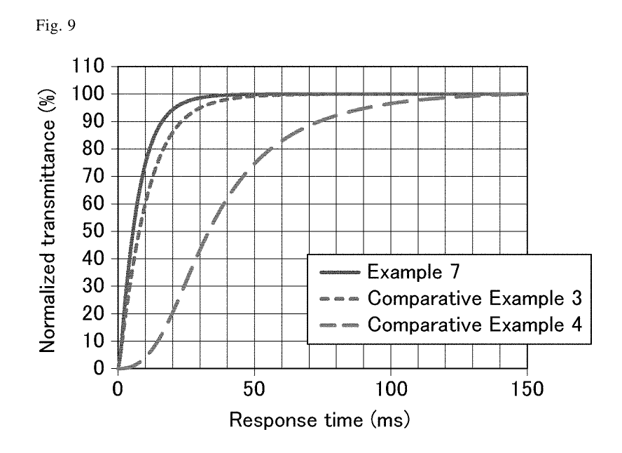

FIG. 9 is a graph comparing the response characteristics between Example 7 and Comparative Examples 3 and 4 during switching from the voltage-off state to the voltage-on state.

Table 4 shows evaluation parameters and the results relating to the response characteristics.

TABLE 4

| | | Comparative | Comparative |
|---|---|---|---|
| | Example 7 | Example 3 | Example 4 |
| Initial alignment (°) | 45 | 7 | 7 |
| against the electrode (slit) | | | |
| Anisotropy of dielectric constant | positive | positive | positive |
| of liquid crystal | | | |
| Electrode width L/Slit width | 3/3 | 3/3 | 7/10 |
| S (μm) | | | |
| T10% to T90% response time | 14.7 | 21.5 | 58.8 |
| (ms) | | | |

The results shown in Table 4 and FIG. 9 demonstrate that the response time of Example 7 can be shortened than that of Comparative Examples 3 and 4. The reason for this is as follows. In Comparative Example 3 which employs a common FFS mode, liquid crystal is rotated only by the fringe electric fields of the lower substrate. In contrast, in Example 7, liquid crystal is rotated by the fringe electric fields of both of the upper and lower substrates so that the liquid crystal molecules in the entire region of the liquid crystal layer can rotate faster. The reason that the Comparative Example 4 fails to achieve high-speed response in spite that liquid crystal molecules are rotated by the transverse electric fields of both of the upper and lower substrates is as follows. Since Comparative Example 4 employs an IPS electrode structure to generate transverse electric fields, liquid crystal molecules between the electrodes have an equal potential in the thickness direction of the liquid crystal layer as shown in FIG. 20 so that liquid crystal molecules above the electrodes are less likely to rotate.

In conclusion, a liquid crystal display using a liquid crystal with positive anisotropy of dielectric constant can achieve faster response than the conventional FFS-mode liquid crystal display similarly to the case of a liquid crystal display using a liquid crystal with negative anisotropy of dielectric constant.

### Examples 8 to 12

Liquid crystal display devices of Examples 8 to 12 have the same configuration as that of Example 7 except that the angle formed by the initial alignment of liquid crystal molecules and the extending direction of the slits of the pixel electrodes (initial alignment angle of liquid crystal molecules) is changed as shown in the below Table 5.

Table 5 shows: (A) the angle formed by the initial alignment of liquid crystal molecules and the extending direction of the slits of the pixel electrodes, (B) the T10% to T90% response time, (C) the transmittance of white display, and (D) the value obtained by dividing the T10% to T90% response time (ms) by the transmittance (%) (response time/transmittance), of the liquid crystal display devices of Examples 8 to 12 and Comparative Example 3.

TABLE 5

| | | Response | Trans- | Response time/ |
|---|---|---|---|---|
| | Slit width | time | mittance | Transmittance |
| | (μm) | (ms) | (%) | (ms/%) |
| Example 8 | 10 | 17.2 | 38.5 | 0.447 |
| Example 9 | 20 | 15 | 38.4 | 0.391 |
| Example 10 | 30 | 9.7 | 37.9 | 0.256 |
| Example 11 | 40 | 13.4 | 36.4 | 0.368 |
| Example 7 | 45 | 14.7 | 33.7 | 0.436 |
| Example 12 | 50 | 16 | 30.1 | 0.532 |
| Comparative | 7 | 21.5 | 33.6 | 0.641 |
| Example 3 | | | | |

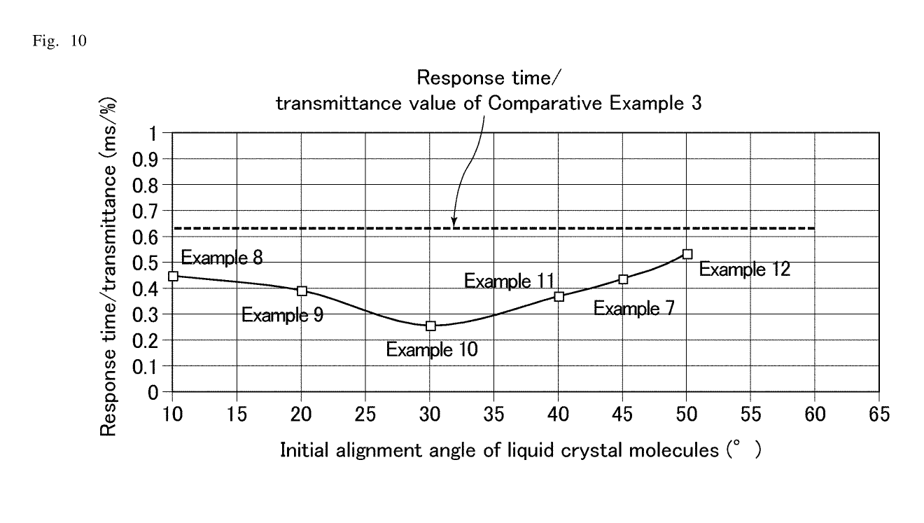

FIG. 10 is a graph showing a relation between the initial alignment angle of liquid crystal molecules and the ratio of response time/transmittance in Examples 8 to 12 and Comparative Example 3. The values of Examples 7 to 12 were plotted in the graph where the initial alignment angle of liquid crystal molecules is represented by the horizontal axis and the ratio of response time/transmittance is represented by the vertical axis. As shown in FIG. 10, when liquid crystal molecules having positive anisotropy of dielectric constant are used in the novel display mode of the present invention, the initial alignment angle of the liquid crystal molecules is preferably 10° or larger, more preferably 20° or larger, while preferably 50° or smaller, more preferably 45° or smaller, still more preferably 40° or smaller.

### [Additional Remarks]

The above embodiment and examples lead to the following modes of the present invention. The modes of the present invention may appropriately be combined with each other within the spirit of the present invention.

One mode of the present invention may be a liquid crystal display device including: a first substrate 10 with a first fringe electric field structure; a second substrate 20 with a second fringe electric field structure; and a liquid crystal layer 30 interposed between the first substrate 10 and the second substrate 20, the first fringe electric field structure including a first planar electrode 12, a first slit electrode 14, and a first insulating film 13 interposed between the first planar electrode 12 and the first slit electrode 14, the second fringe electric field structure including a second planar electrode 22, a second slit electrode 24, and a second insulating film 23 interposed between the second planar electrode 22 and the second slit electrode 24, the liquid crystal layer 30 including liquid crystal molecules 31 that align horizontally to the substrate surfacesalignment azimuth of the first substrate 10 and the second substrate 20 with no voltage applied, the liquid crystal molecules 31 in the vicinity of the first substrate 10 and the liquid crystal molecules 31 in the vicinity of the second substrate 20 being configured to rotate in the same direction from the alignment azimuth with no voltage applied when voltage is applied to each of the first fringe electric field structure and the second fringe electric field structure.

According to the liquid crystal display device of the above mode, the liquid crystal molecules 31 in the entire region of the liquid crystal layer 30 can rapidly respond to the applied voltage by generating oblique electric fields in the liquid crystal layer 30 by both of the first fringe electric field structure and the second fringe electric field structure. Moreover, a high transmittance can be achieved by rotating the liquid crystal molecules 31 in the vicinity of the first substrate 10 and the liquid crystal molecules 31 in the vicinity of the second substrate 20 in the same direction from the alignment azimuth with no voltage applied when voltage is applied to each of the first fringe electric field structure and the second fringe electric field structure.

In the above mode, the first slit electrode 14 has a slit in an extending direction, the second slit electrode 24 has a slit in an extending direction, and the extending directions are preferably parallel to each other. Making the extending directions of the slits in the respective electrodes parallel to each other allows the liquid crystal molecules 31 in the vicinity of the first substrate 10 and the liquid crystal molecules 31 in the vicinity of the second substrate 20 to sufficiently rotate.

In the above mode, the liquid crystal molecules 31 may have negative or positive anisotropy of dielectric constant. In the case of the liquid crystal molecules 31 with negative anisotropy of dielectric constant, the liquid crystal molecules 31 with no voltage applied each preferably have a major axis direction forming an angle of 35° or larger but 70° or smaller with the extending direction of each slit formed on the first slit electrode 14 and the second slit electrode 24. In the case of the liquid crystal molecules 31 with positive anisotropy of dielectric constant, the liquid crystal molecules 31 with no voltage applied each preferably have a major axis direction forming an angle of 50° or smaller with the extending direction of each slit formed on the first slit electrode 14 and the second slit electrode 24. An initial alignment angle of the liquid crystal molecules 31 within the above range enables both of the response time and the transmittance at a high level.

In the above mode, each slit formed on the first slit electrode 14 and the second slit electrode 24 preferably has a width of 3 μm or longer but 7 μm or shorter. A slit width within the above range enables both of the response time and the transmittance at a high level.

### REFERENCE SIGNS LIST

10: first substrate
11: transparent substrate
12: first planar electrode
13: first insulating film
14: first slit electrode
20: second substrate
21: transparent substrate
22: second planar electrode (counter electrode)
23: second insulating film (inorganic insulating film)
24: second slit electrode (pixel electrode)
30: liquid crystal layer
31, 31a, 31b, 31c, 31d: liquid crystal molecule
110, 210: upper substrate
120, 220: lower substrate
122: counter electrode
124: pixel electrode
130, 230: liquid crystal layer
131, 132, 231, 232: liquid crystal molecule
212, 222: common electrode
213, 223: inorganic insulating film
214, 224: pixel electrode
D: initial alignment azimuth
E: direction of electric field
L: electrode width
S: slit width (electrode spacing)

1. A liquid crystal display device comprising:
a first substrate with a first fringe electric field structure;
a second substrate with a second fringe electric field structure; and
a liquid crystal layer interposed between the first substrate and the second substrate,
the first fringe electric field structure including a first planar electrode, a first slit electrode, and a first insulating film interposed between the first planar electrode and the first slit electrode,
the second fringe electric field structure including a second planar electrode, a second slit electrode, and a second insulating film interposed between the second planar electrode and the second slit electrode,
the liquid crystal layer including liquid crystal molecules that align horizontally to the substrate surfaces of the first substrate and the second substrate with no voltage applied,
the liquid crystal molecules in the vicinity of the first substrate and the liquid crystal molecules in the vicinity of the second substrate being configured to rotate in the same direction from the alignment azimuth with no voltage applied when voltage is applied to each of the first fringe electric field structure and the second fringe electric field structure.

2. The liquid crystal display device according to claim 1,
wherein the first slit electrode has a slit in an extending direction, the second slit electrode has a slit in an extending direction, and the extending directions are parallel to each other.

3. The liquid crystal display device according to claim 1,
wherein the liquid crystal molecules have negative anisotropy of dielectric constant.

4. The liquid crystal display device according to claim 3,
wherein the liquid crystal molecules with no voltage applied each have a major axis direction forming an angle of 35° or larger but 70° or smaller with the extending direction of each slit formed on the first slit electrode and the second slit electrode.

5. The liquid crystal display device according to claim 1,
wherein the liquid crystal molecules have positive anisotropy of dielectric constant.

6. The liquid crystal display device according to claim 5,
wherein the liquid crystal molecules with no voltage applied each have a major axis direction forming an angle of 50° or smaller with the extending direction of each slit formed on the first slit electrode and the second slit electrode.

7. The liquid crystal display device according to claim 1,
wherein each slit formed on the first slit electrode and the second slit electrode has a width of 2 μm or longer but 7 μm or shorter.
